(19) United States
(12) Patent Application Publication
(10) Pub. No.: US 2025/0073628 A1
(43) Pub. Date: Mar. 6, 2025

(54) Air Filter That Is Easy To Replace And Install

(71) Applicant: Focus & Co., (Far East) Limited, Hong Kong (CN)

(72) Inventors: Kit Fong WONG, Hong Kong (CN); Ki Ching Teddy MIAO, Hong Kong (CN)

(21) Appl. No.: 18/817,280

(22) Filed: Aug. 28, 2024

(30) Foreign Application Priority Data
Aug. 30, 2023 (CN) 202322340310.5

(51) Int. Cl. B01D 46/88; B01D 46/52

(52) U.S. Cl. CPC B01D 46/88; B01D 46/521

(57) ABSTRACT

The present disclosure discloses an air filter that is easy to replace and install, the air filter including edge strips, corner connectors, and a filter element, wherein the edge strips and the corner connectors are connected to each other via mortise and tenon structures to form a frame; and the filter element is fixed within the frame by means of a connection member, the filter element has a plurality of pleats parallel to each other, and flexible cords are provided between adjacent pleats on at least one of an air intake side and an air discharge side. The air filter of some examples of the present disclosure can be conveniently disassembled in situ, and can be disassembled into components during storage and transportation, thereby reducing the space occupied during the storage and transportation, and facilitating the reduction of the cost of storage and transportation. The frame can be reused, thereby producing less waste and being more environmentally friendly. It is also possible to replace only damaged components when the frame is damaged, so that the cost of maintenance is low. It is possible to replace only the filter element, so that the cost of use is also significantly reduced.

### TECHNICAL FIELD

The present disclosure relates to the field of air purification, and in particular to an air filter that is easy to replace and install.

### BACKGROUND ART

Air filters can filter particulate contaminants, germs, etc., to help improve air quality and reduce the spread of germs. As people's requirements for air quality increase, the air filters are increasingly used in malls, hospitals, laboratories, factories, etc. After a period of use, the air filters will adsorb a large amount of particulate contaminants, etc., which not only will result in a reduction in the rate of air exchange, but more importantly, will result in a significant reduction in the air purification effect. In order to ensure the air purification effect, the air filters need to be replaced or purified.

A conventional air filter includes a frame, inside which a filter element is fixed. The frame and the filter element are fixed in one piece, and are replaced as a whole during replacement. Such an integrated air filter is expensive to manufacture and occupies a large space, resulting in a corresponding increase in the cost of transportation. The frame of the air filter is generally made of an alloy material or an alloy-containing composite material, whereas the filter element is generally made of a polymer material such as non-woven fabric. The frame and the filter element use different materials, and thus need to be recycled separately, making recycling difficult and the recycling cost relatively high.

As China pays more and more attention to environmental protection and the requirements for the recycling of waste are getting higher and higher, people have to consider the costs associated with the disposal of waste materials when using air filters. These costs include, but are not limited to, the cost of transporting the waste to landfills or incinerators, the cost of treating the waste prior to disposal, and the cost of disposing of the waste in landfills or incinerators. It is foreseeable that the cost of conventional integrated air filters will increase further as environmental regulations become stricter due to the difficulty in recycling. Outdated air filters do not conform to the concept of sustainable development and are not environmentally friendly. Therefore, it is necessary to develop a new type of air filter.

### SUMMARY OF INVENTION

An objective of the present disclosure is to provide an air filter that is easy to replace and install, in order to overcome at least one of the deficiencies of the prior art.

A technical solution adopted by the present disclosure is:
an air filter that is easy to replace and install, the air filter including edge strips, corner connectors, and a filter element, wherein
the edge strips and the corner connectors are connected to each other via mortise and tenon structures to form a frame; and
the filter element is fixed within the frame by means of a connection member, the filter element has a plurality of pleats parallel to each other, and a flexible cord is provided between adjacent pleats on at least one of an air intake side and an air discharge side.

In some examples of the air filter, the edge strip is provided with slots at two ends thereof, and the corner connector is provided with corresponding joints.

In some examples of the air filter, the edge strip has a side edge extending to a bottom side.

In some examples of the air filter, the side edge has a bottom support extending to an inner side.

In some examples of the air filter, the edge strip has a side edge extending to a bottom side, and the side edge has a bottom support extending to an inner side.

In some examples of the air filter, the edge strip has an upper edge extending to an inner side.

In some examples of the air filter, the edge strip has a side edge extending to a bottom side, and the edge strip has an upper edge extending to an inner side.

In some examples of the air filter, the edge strip has a side edge extending to a bottom side, the side edge has a bottom support extending to an inner side, and the edge strip has an upper edge extending to the inner side.

In some examples of the air filter, the corner connector has a corner edge extending to a bottom side.

In some examples of the air filter, the corner edge has a corner support extending to an inner side.

In some examples of the air filter, the corner connector has a corner edge extending to a bottom side, and the corner edge has a corner support extending to an inner side.

In some examples of the air filter, the pleats are provided with side leakage protection filter layers at two ends (on two sides) thereof.

In some examples of the air filter, a surface of the filter element is provided with two or more flexible cords.

In some examples of the air filter, the pleats are provided with side leakage protection filter layers at two ends thereof, and a surface of the filter element is provided with two or more flexible cords.

In some examples of the air filter, the connection member is selected from a hook-and-loop fastener, a clip or a snap fastener.

The present disclosure has the following beneficial effects.

The air filter of some examples of the present disclosure can be conveniently disassembled in situ, and can be disassembled into components during storage and transportation, thereby reducing the space occupied during the storage and transportation, and facilitating the reduction of the cost of storage and transportation.

In some examples of the air filter of the present disclosure, the frame can be reused, thereby producing less waste and being more environmentally friendly. It is also possible to replace only damaged components when the frame is damaged, so that the cost of maintenance is low.

In some examples of the air filter of the present disclosure, it is possible to replace only the filter element, so that the cost of use is also significantly reduced.

In some examples of the air filter of the present disclosure, by providing the flexible cord between the pleats, the reduction of the local effective filtering area caused by too large or too small pleat spacing is avoided, and the air purification effect is effectively guaranteed.

### BRIEF DESCRIPTION OF THE DRAWINGS

FIG. 1 is a schematic view of the overall structure of an air filter of the present disclosure.

FIG. 2 is a schematic view of the overall structure of a frame of an air filter of the present disclosure.

FIG. 3 is a schematic view of a partial structure of a frame of an air filter of the present disclosure.

FIG. 4 is a schematic view of the structure of an edge strip of the present disclosure.

FIG. 5 is a schematic view of the structure of a corner connector of the present disclosure.

FIG. 6 is a schematic view of a partial structure of a filter element of the present disclosure.

### LIST OF REFERENCE SIGNS

Edge strip—1, side edge—11, bottom support—12, upper edge—13, slot—14
Corner connector—2, corner edge—21, corner support—22, joint—23
Filter element—3, pleat—31, flexible cord—32, side leakage protection filter layer—33
Frame—4
Connection member—5.

### DETAILED DESCRIPTION OF EMBODIMENTS

Implementations of the present disclosure will be described in detail below, and examples of the implementations are shown in the accompanying drawings, in which the same or similar reference signs throughout refer to the same or similar elements or the elements having the same or similar functions. The implementations described below with reference to the accompanying drawings are exemplary and are merely intended to be illustrative of the present disclosure, but should not be construed as limiting the present disclosure.

In the description of the present disclosure, it should be understood that orientation or position relationships indicated by terms “upper”, “lower”, “front”, “rear”, “left”, “right”, etc. are orientation or position relationships shown in the accompanying drawings, and these terms are just used to facilitate description of the present disclosure and simplify the description, but not to indicate or imply that the mentioned device or element must have a specific orientation and must be constructed and operated in a specific orientation, and thus cannot be construed as a limitation to the present disclosure.

In the description of the present disclosure, “several” means one or more, “a plurality of” means two or more, “greater than”, “less than”, “over” and the like are construed as excluding the number, and “above”, “below”, “within”, and the like are construed as including the number. The “first” and “second” in the description are merely intended to distinguish technical features, and cannot be construed as indicating or implying relative importance or implicitly indicating a number of the indicated technical features or implicitly indicating a sequence relationship of the indicated technical features.

In addition, the terms “first” and “second” are used for descriptive purposes only, and cannot be construed as indicating or implying relative importance or implicitly indicating the number of technical features indicated. Thus, features defined with “first” and “second” may explicitly or implicitly include one or more of the features.

In the description of the present disclosure, it should also be noted that, unless otherwise clearly specified or limited, the term “connection” should be understood in a broad sense, for example, they may be a fixed or movable connection, a detachable or non-detachable connection, or an integrated connection; may be a mechanical connection, or an electrical connection, or mutual communication; or may be a direct connection or an indirect connection by means of an intermediate medium, or may be internal communication between two elements, indirect communication, or interaction between the two elements.

The disclosure below provides various implementations or examples for implementing different solutions of the present disclosure.

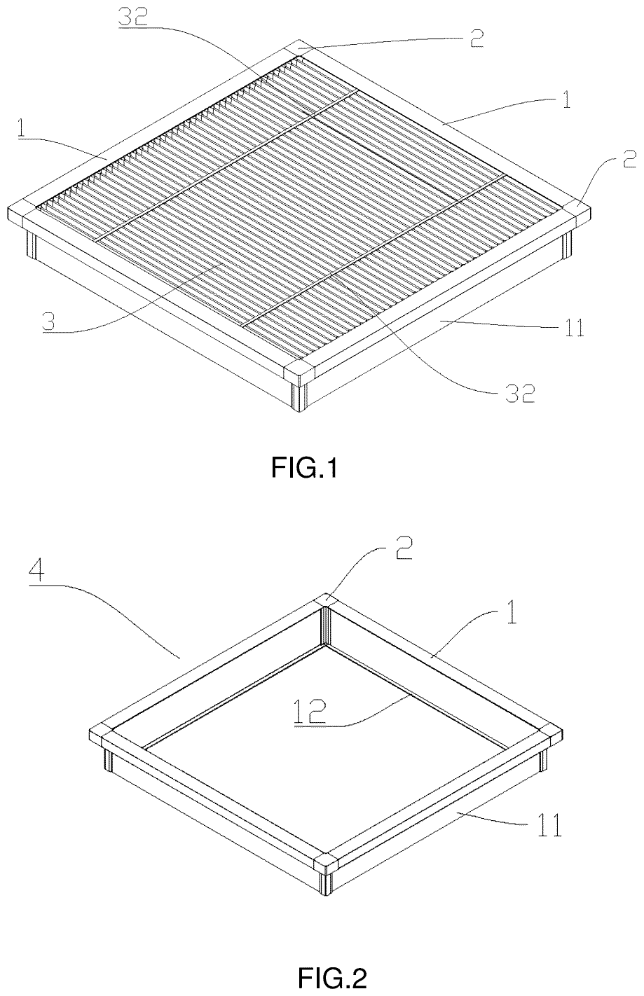

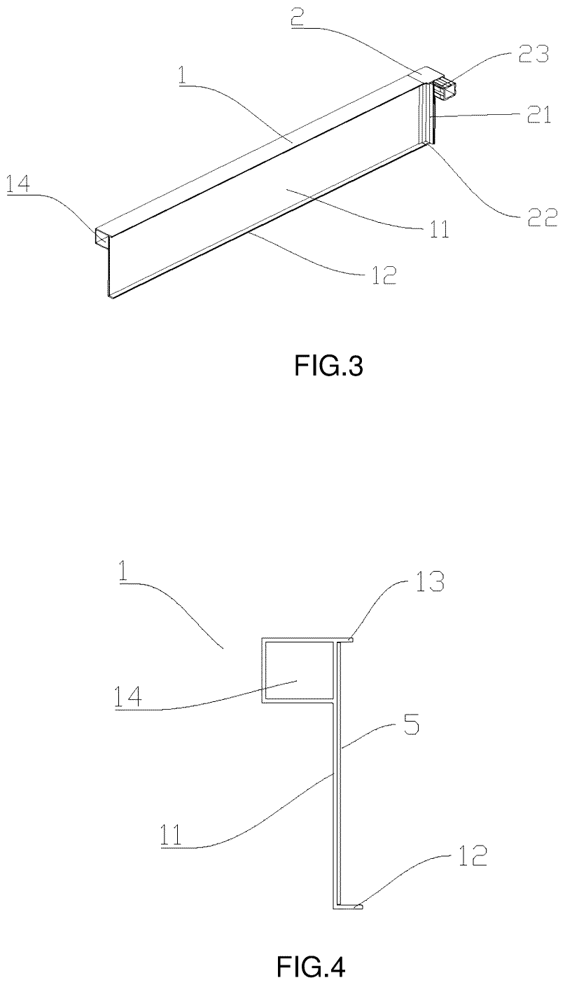

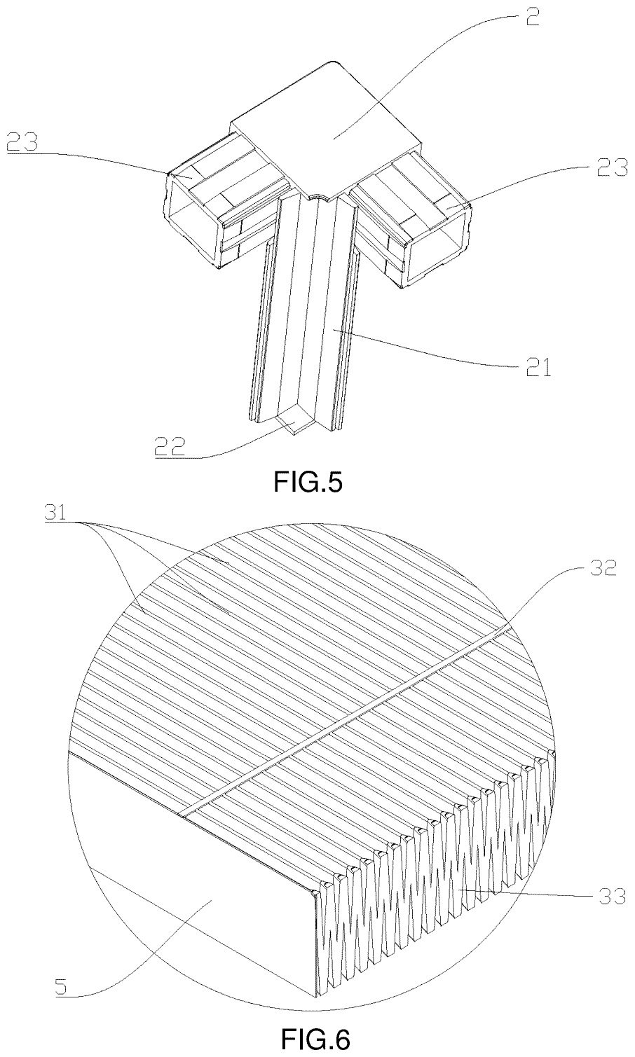

With reference to FIGS. 1 to 6, an air filter that is easy to replace and install includes edge strips 1, corner connectors 2, and a filter element 3.

The edge strips 1 and the corner connectors 2 are connected to each other via mortise and tenon structures. The edge strips 1 and the corner connectors 2 are connected to each other to form a frame 4.

The filter element 3 is fixed within the frame 4 by means of a connection member 5, the filter element 3 has a plurality of pleats 31 parallel to each other, and a flexible cord 32 is provided between adjacent pleats 31 on at least one of an air intake side and an air discharge side.

The frame can be simply assembled on site, and can be disassembled and packaged separately during storage and transportation, occupying little space, and facilitating the reduction of the cost of storage and transportation. When the filter element needs to be replaced, it just needs to directly remove the filter element and fix a new filter element within the frame by means of a connection member. It is also possible to replace only damaged components when the frame is damaged, so that the cost of maintenance is low. The flexible cord is easy to fold, and the pleats can have and maintain the designed maximum spacing after unfolding the flexible cord.

In some examples of the air filter, the edge strip 1 is provided with slots 14 at two ends thereof, and the corner connector 2 is provided with corresponding joints 23. This makes it easier to manufacture.

In some examples of the air filter, the edge strip 1 has a side edge 11 extending to a bottom side. This can allow for better accommodation of the filter element.

In some examples of the air filter, the side edge 11 has a bottom support 12 extending to an inner side. This can allow for better support of the unfolded filter element.

In some examples of the air filter, the edge strip 1 has a side edge 11 extending to a bottom side, and the side edge 11 has a bottom support 12 extending to an inner side.

In some examples of the air filter, the edge strip 1 has an upper edge 13 extending to an inner side. This can prevent the unfolded filter element from being easily removed, and simplify a filter element fixing structure.

In some examples of the air filter, the edge strip 1 has a side edge 11 extending to a bottom side, and the edge strip 1 has an upper edge 13 extending to an inner side.

In some examples of the air filter, the edge strip 1 has a side edge 11 extending to a bottom side, the side edge 11 has a bottom support 12 extending to an inner side, and the edge strip 1 has an upper edge 13 extending to the inner side.

The edge strip can be formed from an aluminum material and then cut to a designed length. The edge strip is preferably flat at two ends thereof, so that it is convenient for assembly and also can make full use of a profile, avoiding the generation of sharp surfaces and providing better safety.

In some examples of the air filter, the corner connector 2 has a corner edge 21 extending to a bottom side. This can allow for better accommodation of the filter element.

In some examples of the air filter, the corner edge 21 has a corner support 22 extending to an inner side. This can allow for better support of the unfolded filter element.

In some examples of the air filter, the corner connector 2 has a corner edge 21 extending to a bottom side, and the corner edge 21 has a corner support 22 extending to an inner side.

In some examples of the air filter, the pleats 31 are provided with side leakage protection filter layers 33 at two ends (on two sides) thereof. This can reduce the amount of air that bypasses the filter element.

In some examples of the air filter, a surface of the filter element 3 is provided with two or more flexible cords 32. The number of flexible cords can be adjusted according to the size of the filter element. Flexible cords on the same plane are preferably designed parallel to each other. In particular, the flexible cord may be fixed to the pleats by ultrasonic welding, gluing, etc.

In some examples of the air filter, the pleats 31 are provided with side leakage protection filter layers 33 at two ends thereof, and a surface of the filter element 3 is provided with two or more flexible cords 32.

In some examples of the air filter, the connection member 5 is selected from a hook-and-loop fastener, a clip or a snap fastener. It is preferred to use a hook-and-loop fastener. The hook-and-loop fastener allows for easy attachment and detachment, and is tight after attachment, with a good sealing effect.

### Embodiment 1

With reference to FIGS. 1 to 6, an air filter that is easy to replace and install includes edge strips 1, corner connectors 2, and a filter element 3.

The edge strip 1 has a through hole penetrating two ends thereof, the through hole serving as slots 14 and joints 23 are connected to each other, the edge strip 1 has a side edge 11 extending to a bottom side, and the side edge 11 has a bottom support 12 extending to an inner side.

The corner connector 2 is provided at two ends with joints 23 matching the through hole, and has a corner edge 21 extending to the bottom side, and the corner edge 21 has a corner support 22 extending to the inner side.

Four edge strips 1 and four corner connectors 2 are connected to each other to form a frame 4. A hook side of a hook-and-loop fastener is fixed to an inner side of either of two parallel edge strips 1 of the frame 4.

A loop side of the hook-and-loop fastener is provided at either end of the filter element 3. The filter element 3 has a plurality of pleats 31 parallel to each other, and flexible cords 32 are ultrasonically welded and fixed to the pleats 31 on an air intake side and an air discharge side. The lengths of the flexible cord 32 between adjacent pleats 31 are the same, and the pleats 31 are provided with side leakage protection filter layers 33 at two ends thereof.

The filter element 3 is fixed within the frame 4 by means of hook-and-loop fasteners, and after the filter element 3 is unfolded, the air discharge side is supported by the bottom supports 12 and the corner supports 22, the air intake side is defined by the upper edges 13 of the edge strips 1, and the periphery of the filter element is attached to the side edges 11 of the edge strips 1 and the corner edges 21 of the corner connectors 2.

The above is a further detailed description of the present disclosure, and should not be regarded as a limitation on the specific implementation of the present disclosure. For those of ordinary skill in the art of the present disclosure, simple deductions or substitutions without departing from the spirit of the present disclosure should fall within the scope of protection of the present disclosure.

1. An air filter that is easy to replace and install, the air filter comprising edge strips, corner connectors, and a filter element, wherein
the edge strips and the corner connectors are connected to each other via mortise and tenon structures to form a frame; and
the filter element is fixed within the frame by means of a connection member, the filter element has a plurality of pleats parallel to each other, and a flexible cord is provided between adjacent pleats on at least one of an air intake side and an air discharge side.

2. The air filter according to claim 1, wherein the edge strip is provided with slots at two ends thereof, and the corner connector is provided with corresponding joints.

3. The air filter according to claim 1, wherein the edge strip has a side edge extending to a bottom side.

4. The air filter according to claim 3, wherein the side edge has a bottom support extending to an inner side.

5. The air filter according to claim 1, wherein the corner connector has a corner edge extending to a bottom side.

6. The air filter according to claim 5, wherein the corner edge has a corner support extending to an inner side.

7. The air filter according to claim 1, wherein the connection member is selected from a hook-and-loop fastener, a clip or a snap fastener.

8. The air filter according to claim 1, wherein the pleats are provided with side leakage protection filter layers at two ends thereof.

9. The air filter according to claim 1, wherein a surface of the filter element is provided with two or more flexible cords.

10. The air filter according to claim 1, wherein the edge strip has an upper edge extending to an inner side.
